(19) United States
(12) Patent Application Publication
(10) Pub. No.: US 2004/0186797 A1
(43) Pub. Date: Sep. 23, 2004

(54) System and method for servicing construction equipment

(75) Inventors: Werner Schwind, Dachau (DE); Christopher Barnard, Mequon, WI (US); David J. Christifulli, Sussex, WI (US); Peter B. Liesch, Burlington, WI (US); Daniel W. Bennett, Jackson, WI (US)

Correspondence Address: Steven C. Becker, Foley & Lardner, Suite 3800, 777 East Wisconsin Avenue, Milwaukee, WI, 53202-5306, US

(73) Assignee: Wacker Corporation

(21) Appl. No.: 10/685,123

(22) Filed: Oct. 14, 2003

Related U.S. Application Data
(60) Provisional application No. 60/456,664, filed on Mar. 21, 2003.

(51) Int. Cl. G06F 17/60

(52) U.S. Cl. 705/29

(57) ABSTRACT

A method of servicing construction equipment comprising forming an association of construction equipment manufacturers and providing a service agent of the association. The service agent refers a service need to a service dealer. The service agent is not an agent of the service dealer to whom the service need is referred.

### CROSS-REFERENCE TO RELATED APPLICATIONS

This application claims the benefit of U.S. Provisional Application No. 60/456,664, filed Mar. 21, 2003.

### BACKGROUND

In the field of sales, service, and rental of construction equipment, one challenge has been the prompt, efficient, and cost-effective service of construction equipment used on the construction job site. Construction equipment, such as, rammers, plates, rollers and other soil compaction equipment typically require service to maintain optimal performance, so that down time is minimized.

Several service channels are available for construction equipment. One channel is the independent equipment dealer. The independent equipment dealer is typically a privately-held company, which is often family-owned. It often sells construction equipment and offers service of the equipment that it sells. It also offers service to a broader range of equipment than it sells. Due in part to its small size, the independent equipment dealer has a reputation for focusing on good customer service.

Another service channel available for construction equipment is the consolidator. Consolidators have grown in size by acquiring independent equipment dealers, but have been criticized in recent years for not maintaining the same level of customer service as the independent equipment dealers they acquire. Some consolidators have not been able to maintain the geographic coverage or the efficiency of the independent equipment dealers—leading to service gaps. For example, some consolidators do not carry an adequate inventory of parts to fix the equipment quickly, which can extend service time from two days or a week to two to four weeks or more.

Manufacturers of construction equipment have a need to reduce service gaps in order to improve sales of their products, market penetration, etc. One approach has been for the manufacturers to provide service through a direct service channel, in which the service employee is employed directly by the manufacturer. While this allows manufacturers to directly control the service of their products, it is prohibitively costly, particularly for smaller manufacturers, and is typically outside the manufacturer's core business.

Another approach has been for the manufacturers to train and certify employees of service dealers in geographic areas having the widest service gaps. Although certification may improve the quality of the service provided, it does not address the problems of service coverage or inventory of replacement parts. In particular, the interests of the service dealer are not always coextensive with that of the manufacturers. Thus, in this approach, the manufacturers of construction equipment do not have sufficient control over service provided at the job site for their equipment. As a result, product sales and goodwill of the manufacturers are hurt.

In some cases, contractors on the job site directly service their own construction equipment. Although the contractors would rather refer the service needs to another party, service gaps lead the contractors to service the equipment on their own.

Accordingly, what is needed is a system and method for improving the service of construction equipment. Further, what is needed is a system and method for reducing gaps in the service of construction equipment. Further still, what is needed is a system and method for servicing construction equipment that provides equipment manufacturers with more control over the service provided to the construction equipment without the costs and complexities of maintaining a direct service channel. Further still, what is needed is a system and method for improving customer service for construction equipment from a plurality of manufacturers who make products over a range of product lines.

The teachings hereinbelow extend to those embodiments which fall within the scope of the appended claims, regardless of whether they accomplish one or more of the above-mentioned needs.

### SUMMARY

According to one exemplary embodiment, a method of servicing construction equipment comprises forming an association of construction equipment manufacturers and providing a service agent of the association. The service agent refers a service need to a service dealer. The service agent is not an agent of the service dealer to whom the service need is referred.

According to another exemplary embodiment, a method of servicing construction equipment comprises forming a consortium of construction equipment manufacturers and providing a service agent. The service agent is an employee or independent contractor of the consortium and the service agent refers a service need to a service dealer.

According to another exemplary embodiment, a method of servicing construction equipment comprises providing a service agent who is an agent of an association of construction equipment manufacturers and referring a service need with the service agent to a service dealer. The service agent is not an agent of the service dealer to whom the service need is referred.

According to yet another exemplary embodiment, an organization for a service system for construction equipment comprises an association of construction equipment manufacturers, a service agent for processing service needs for the construction equipment, and a plurality of service dealers. The service agent is hired by the association and selects one of the service dealers to provide for the service need.

According to another exemplary embodiment, an association of construction equipment manufacturers comprises a computer system configured to facilitate purchase orders between a service dealer and a manufacturer and further comprises a service agent, which is an agent of the association. The service agent refers service needs to the service dealer.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a schematic general block diagram illustrating a system for servicing construction equipment, according to an exemplary embodiment;

FIG. 2 is a schematic general block diagram of a field team structure, according to an exemplary embodiment;

FIG. 3 is a flowchart illustrating a method of servicing construction equipment, according to an exemplary embodiment; and

FIG. 4 is a schematic general block diagram of a system and method of servicing construction equipment, according to an exemplary embodiment.

### DETAILED DESCRIPTION OF EXEMPLARY EMBODIMENTS

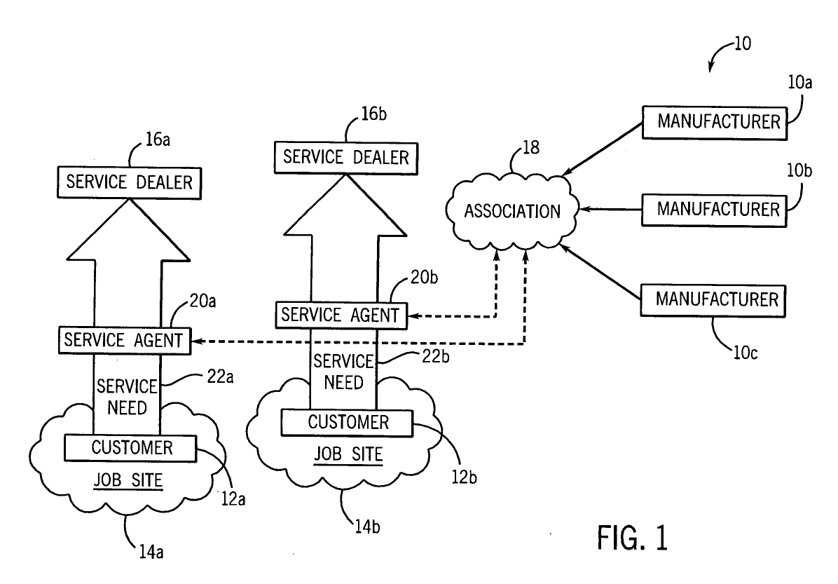

Referring to FIGS. 1-3, a system and method for servicing construction equipment is shown. In FIG. 1, the diagram illustrates in schematic form a plurality of manufacturers 10a, b, or c. Manufacturers 10a, b, or c each manufacture one or more products in one or more product lines. For example, manufacturer 10a can be a maker or assembler of light construction equipment, and can further be a maker or assembler of a group of soil compaction products in a soil compaction product line. The term “equipment” includes products, components, product assemblies, and sets of articles of various sizes and costs. Soil compaction products can include rammers, plates, rollers, etc. Other product lines including products suitable for the light construction equipment industry can include demolition equipment, pumps, power supply units, lighting systems, concrete products, air compressors, etc. The term “light construction equipment” refers to products suitable for use in the construction industry weighing approximately 2-½ tons or less. The system and method disclosed herein is particularly suited for manufacturers in the light construction equipment industry, but may alternatively be applied to other industries or applications.

Manufacturers 10a, b, or c can be corporations, partnerships, franchisers, etc. and can also act as distributors. Manufacturers 10a, b, or c sell their products to customers 12a or b through any of a number of sales channels comprising sales dealers. Customers 12a or b can be general contractors, subcontractors, equipment dealers or other persons having a need for the equipment manufactured by manufacturers 10a, b, or c for use at job sites 14a or b. The term “person” refers to one who is recognized by law as the subject of rights and duties, such as, a corporation, a partnership, or a human being.

Equipment is provided from manufacturers 10a, b, or c to customers 12a or b through any of a number of distribution channels, which include sales and rental channels. One exemplary person in the sales channel is the independent equipment dealer which is a company whose primary focus is sales of the equipment from manufacturers 10a, b, or c. Exemplary independent equipment dealers include Lincoln Contractors Supply, Milwaukee, Wis. In most cases, the independent equipment dealer will not provide service beyond one or several states. Another person in the sales channel is the manufacturer 10a, b, or c, which is in the direct sales channel. Exemplary manufacturers include Wacker Construction Equipment AG, Dresden, Germany, and Ingersoll-Rand Company, Hamilton, Bermuda. In the direct sales channel, manufacturers sell directly to customers 12a or b. Yet another person in the sales channel is an integrated independent dealer which refers to a manufacturer who integrates sales and/or rental in one dealer, wherein the integrated independent dealer may also rent or sell equipment from other manufacturers. Exemplary integrated independent dealers include the CAT Rental division of Caterpillar, Inc., Peoria, Ill. and the Volvo Equipment Rental Station division of the Volvo Group, Gothenburg, Sweden. The rental channels can include persons who buy equipment from manufacturers 10a, b, or c and rent the equipment to customers 12a or b, typically for limited periods of time.

One exemplary person in the rental channel is the consolidator which is a company formed by acquiring other sales, and/or rental dealerships, and typically has a nation-wide or regional presence. The focus of the consolidator is primarily rental. Exemplary consolidators include United Rentals, Inc., Greenwich, Connecticut and Rental Service Corporation, Scottsdale, Ariz. Another exemplary person in the rental channel is the hardware/“Big Box” dealer which is a company which typically sells hardware and rents equipment retail. Exemplary hardware/“Big Box” dealers include Home Depot, Inc., Atlanta, Ga., Lowe's Companies, Inc., Wilkesboro, N.C., and the True Value business of TruServ Corporation, Chicago, Ill.

Customers 12a or b use the purchased or rented equipment at job sites 14a or b in various construction projects, including commercial construction, residential construction, etc. At times, the equipment will have a service need 22. Service needs 22 include the need for replacement parts (such as carburetors, air filters, tires, spark plugs, belts, etc.) and the need for maintenance, repair, replacement, and other service needs of the equipment. Meeting the service needs 22 of the equipment and the customers in a timely, efficient, and cost-effective manner is an important goal of manufacturers 10a, b, or c, because the availability of good service is foremost among the considerations of customer 12 when purchasing or renting equipment, particularly in the construction industry.

According to one advantageous aspect of this exemplary embodiment, and with reference to FIGS. 1 and 3, a system and method for servicing construction equipment comprises forming an association 18 of manufacturers 10a, b, or c (step 50, FIG. 3) and providing one or more service agents 20 who are agents of association 18 from the association (step 52, FIG. 3) to job sites 14a or b (step 54, FIG. 3). The same service agent or other service agents 20 can also be provided to a customer's facility, defined as any location or office that the customer operates from, or to an equipment dealer's facility, defined as any location or office that an equipment dealer operates from. Equipment dealers can include any person in the sales or rental channels, or any other person that buys, sells, rents, or services construction equipment. Service agent 20 refers service needs 22 to service dealers 16a, b (step 56, FIG. 3). Service agent 20 can process service needs 22 by referring the service needs and/or by performing other tasks associated with the referral. Because service agent 20 is an agent of association 18 and not of the service dealer 16 to whom the service need is referred, manufacturers 10a, b, or c are in direct control of the service interface with customers 12a or b, and the manufacturers are able to provide top customer service for equipment manufactured by manufacturers 10a, b, or c at job sites 14a or b.

According to a preferred embodiment, service agent 20 refers service needs 22 to service dealers 16a, b whom are franchisees of association 18. A franchisee is a person who is authorized by association 18 to provide association 18's services and/or goods, and can include persons having various contractual relationships with association 18, such as those authorizing the use of association 18's trade name or names, facilities, market plans, etc., and contractual relationships wherein service agent 20 pays a fee or other royalty to association 18.

Preferably, service agent 20 refers service needs to service dealers who are franchisees of association 18 so that optimal service can be maintained for the equipment of manufacturers 10a, b, or c. In an alternative embodiment, service agent 20 may refer service needs to other service dealers who are not franchisees of association 18. For example, if association 18 does not maintain franchisees in a certain geographic area, or does not maintain franchisee relationships at all, service agent 20 can refer service needs 22 to non-franchisee service dealers. Accordingly, in alternative embodiments, service agents can refer service needs to any person who provides service as a business, such as those who provide service to construction equipment, even if providing service is only a small portion of the person's business. Examples include one or more of the persons in the rental channels and/or sales channels described above, such as consolidators, independent equipment dealers, integrated independent dealers, and hardware/Big Box dealers.

According to another alternative embodiment, service agent 20 may refer service needs 20 to service dealers 16a, b in any service channel except the direct service channel.

Association 18 can take many forms and is, in one exemplary form, an organization of persons having a common interest. An organization is an administrative and functional structure, such as a business, consortium, etc. A consortium is a group of companies formed to undertake an enterprise beyond the resources of any one member, and association 18 can take any of these forms. Association 18 can be a corporation, partnership, or simply a written, contractual agreement between a plurality of manufacturers 10a, b, or c. In a more advanced form, association 18 provides training and supervision of service agent 20, and can even provide inventory database services for service dealers 16a, b, payment arrangements between service dealers 16a, b and manufacturers 10a, b, or c for replacement parts and other products, and even a credit card billing system to facilitate transactions among manufacturers 10a, b, or c, service dealers 16a, b and association 18.

Service agent 20 is a person authorized by association 18 and/or manufacturers 10a, b, or c to act on behalf of association 18. Service agent 20 can be a corporation, partnership, one or more human beings, etc. Service agent 20 is employed by or an independent contractor of association 18 in this exemplary embodiment. Service agent 20 is not employed by or an independent contractor of the service dealer 16 to whom the service need is referred.

Service agent 20 is present at job site 14, and can travel from one job site 14a to another job site 14b, to customer 12a or b's facility, to an equipment dealer's facility, or to other locations. Service agent 20 is trained by association 18 and/or its constituent independent manufacturing companies 10 to understand equipment manufactured by manufacturers 10a, b, or c. Service agent 20 understands the equipment when the agent has sufficient knowledge to identify that the equipment needs service and to make a referral for the service need to service dealer 16. Service agent 20 refers or “pulls” service needs to the service channel comprised of service dealers 16a, b. Many of service dealers 16a, b cannot afford to have an agent on the job site, and therefore, in prior systems, service is not being efficiently referred to service dealers 16a, b. With service agent 20, this problem can be addressed.

In this exemplary embodiment, service agent 20 does not directly provide service to customer 12 at job site 14, but rather refers a service need to service dealers 16a, b whom service agent 20 is not an agent of or employed by. This process is referred to as “pulling” a service need. Because service agent 20 is independent from service dealers 16a, b (i.e., is not controlled by, paid directly by, or hired by service dealers 16a, b), service agent 20 can represent the interests of manufacturers 10a, b, or c. Association 18 trains service agent 20 and controls his actions by nature of employment, commission or other contractual relationship.

According to one exemplary embodiment, a first of manufacturers 10a, b, or c sells equipment in a first product group, such as soil compaction, and a second of manufacturers 10a, b, or c sells equipment in a second product group, such as air compressors, wherein the first and second product groups are in different product lines. By diversifying the product lines that are represented by different manufacturers 10a, b, or c, customers 12a or b can have service solutions from service agent 20 for all or substantially all of customer 12's service needs of construction equipment.

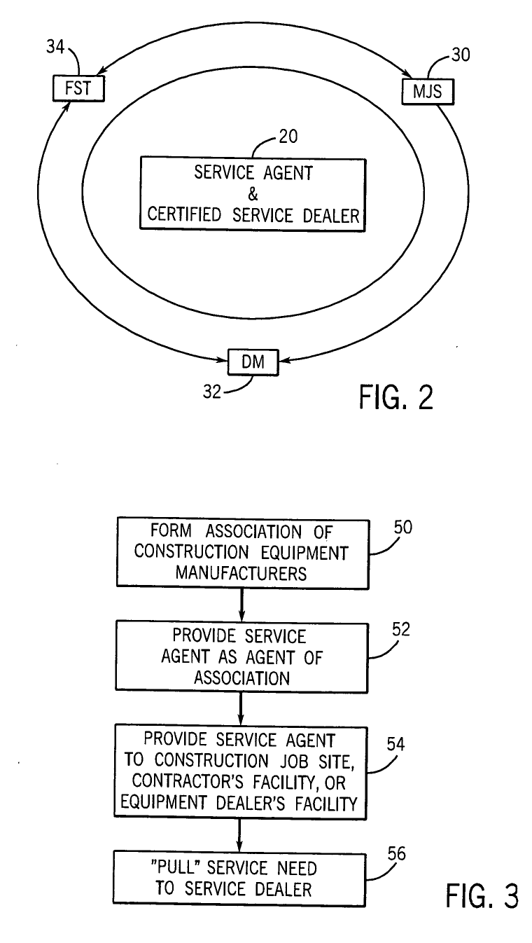

Referring now to FIG. 2, an exemplary field team structure for one of manufacturers 10a, b, or c will be described. The work of service agent 20 can be complimented by the work of a sales agent 30, a district manager 32, and a field service technician 34. Sales agent 30 or “metro job site specialist” (MJS) is an agent, such as an employee or independent contractor, of one of manufacturers 10a, b, or c (or alternatively an agent of association 18) who is provided to job site 14 to demonstrate the equipment of one of manufacturers 10a, b, or c. Sales agent 30 demonstrates the product or equipment and works with customer 12 to find solutions with products of one of manufacturers 10a, b, or c. If customer 12 is interested in purchasing a product, sales agent 30 does not directly sell the product, but rather refers or “pulls” the sale through a sales or rental distribution channel.

Sales agent 30 and service agent 20 (e.g., a “metro service specialist”) communicate with one another, sharing contact information, working together, etc., wherein sales agent 30 refers sales and rental needs through sales and rental channels and service agent 20 refers service needs through service channels.

Field service technician 34 is employed by one of manufacturers 10a, b, or c of association 18. Field service technician 34 provides training and helps with technical issues at job sites 14a or b, spending a majority of time supporting equipment dealers.

According to one exemplary embodiment, association 18 can include a revenue-generating feature wherein service dealers 16a, b and/or manufacturers 10a, b, or c pay a royalty or other fee or cash to association 18 based on referrals by service agent 20, replacement parts ordered by service dealer 16, etc.

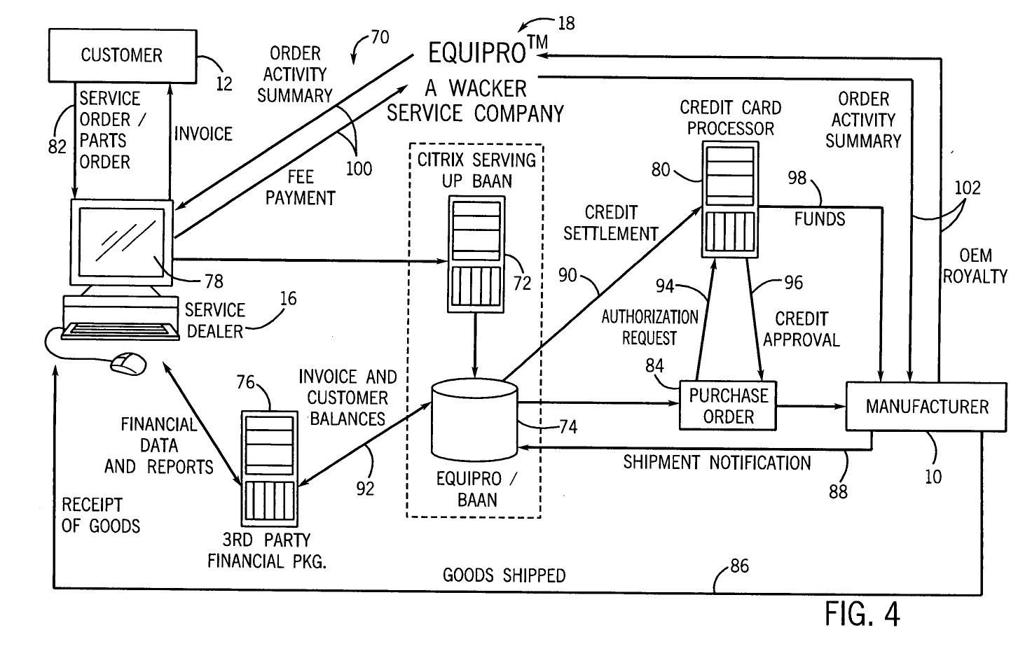

Referring now to FIG. 4, an exemplary system and method is shown. The system illustrates several exemplary features interfacing association 18 with customer 12 and manufacturer 10 using a system 70. System 70 comprises a computer 72 having a database 74. Computer 72 can comprise analog and/or digital electronic components, such as, one or more microprocessors, microcontrollers, etc. In this exemplary embodiment, computer 72 is configured to operate or run software, such as, Enterprise Resource Planning (ERP) software, such as, the Baan Service Module, manufactured by Invensys, PLC, London, England. Computer 72 can operate Citrix software, manufactured by Citrix Systems, Inc., Fort Lauderdale, Fla., to provide internet or web-access of the software to service dealers 16a, b. Computer 72 can be configured to communicate data with a computer 78 located at or associated with service dealers 16a, b and can use an internet protocol-based data format, such that computer 78 can access computer 72 via one or more internet protocol interfaces, such as, a web browser, e.g., Internet Explorer, manufactured by Microsoft Corp., Redmond, Wash. Other communication formats can be used for communications between computer 72 and computer 78. In alternative embodiments, the internet protocol-based communication link can be replaced with other communication links, such as, digital subscriber line (DSL), modems, cable modems, or other technology. Further, computer 78 can be a personal computer, laptop computer, or may be a web browser. Advantageously, where computer 78 is a web browser computer, it can have very little hard drive requirements, memory requirements, etc.

Computer 78 can further be coupled to a computer 76, which can be associated with or located at service dealers 16a, b, and which can operate a financial software package and can be, for example, Quick Books, manufactured by Intuit Inc., San Diego, Calif., or Peachtree, manufactured by Best Software, Inc., Scottsdale, Ariz. Computer 76 is configured to provide financial data and reports for service dealer 16 for one or more of service dealer 16's operations. Computer 76 is configured to communicate invoice and customer balance information with computer 72 via a communication link, which can be an internet protocol-based communication link. Database 74 is configured to operate under control of computer 72 to store and retrieve data for computer 72.

Also shown is a computer system 80 at a bank or other credit card-processing center configured to process credit card transactions in a conventional manner.

In operation, a service agent refers a service need to service dealer 16 from customer 12. Customer 12 submits a service need, which can include an order for service and/or an order for parts to service dealer 16, as indicated at arrow 82. Service dealer 16 operates computer 78, which is configured to determine whether a needed part is in inventory by referring to inventory data for service dealer 16 stored at computer 72. If the needed part is not in inventory for service dealer 16, computer 72 is configured to automatically, or in response to input from service dealer 16 at computer 78, provide a purchase order 84 for one or more of the parts to manufacturer 10. Manufacturer 10 could then provide the parts, as indicated by arrow 86, to service dealer 16. Manufacturer 10 could further provide a shipment notification, arrow 88, to computer 72, so that service dealer 16 can identify when products have been shipped via computers 78 and 72.

Advantageously, computer 72 assists service dealer 16 by managing service dealer 16's inventory. For example, service dealer 16 can maintain repair parts, which would be on hand at the dealership. Service dealer 16 can further maintain maintenance parts, which would be used less frequently and which would be too expensive to maintain at the dealership. Regarding repair parts, for example, air or fuel filters for a rammer, these parts could be replenished anytime the inventory drops to a predetermined number of units, such as, 3 units. Computer 72 can be configured automatically, or by service dealer 16 via computer 78 to ship goods to replenish the inventory at the dealership or stock parts to a second predetermined number of units, such as, 10 units. Advantageously, the burden of inventory management is moved from service dealer 16 to computer 72.

In response to generating purchase order 84, computer 72 can further be configured to forward a credit card number or other credit identification number to a credit card processor, such as, computer system 80, as shown by arrow 90. Computer 72 is configured to provide an invoice to computer 76, as indicated by arrow 92. Computer 72 can further be configured to provide a credit settlement via arrow 90, an authorization request as indicated by arrow 94, and receive credit approval, arrow 96. Upon approval, purchase order 84 can be generated and forwarded to manufacturer 10. The credit card company, indicated also by computer system 80, provides the funds directly to manufacturer 10, arrow 98, which can be transferred by electronic funds transfer (EFT), automated clearing house (ACH) debit, or other transfer methods. Other transfers of funds involving system 70 can use EFT, ACH debit, or other funds transfer methods. Purchase order 84 can further include shipping information, such as, a shipping address, of service dealer 16, said shipping information being stored in database 74. The credit card information can be stored securely in database 74 so that service dealer 16 need not reenter the data each time a parts order is submitted.

Advantageously, manufacturers 10a, b, or c get paid funds from credit card processor 80 immediately or within a few days of shipment of goods. According to a further advantage, a credit card bill received by service dealers 16a, b from credit card processor 80 and/or the invoice and customer balance information received from computer 72, arrow 92, represents a consolidated financial report that is useful for service dealers 16a, b in financial reporting. According to a further advantage, manufacturers 10a, b, or c receive payment in a timely and reliable fashion from credit card processor 80.

Referring now to arrows 100, service dealers 16a, b can provide a fee payment to association 18, which can be a flat fee, a percentage of sales of parts conducted through system 70, and/or some combination of this or other fee arrangements to association 18. Association 18 can provide a summary either electronically or via paper printout to service dealers 16a, b on a periodic basis of all products ordered via system 70. The royalty can further be based on service performed by dealer which was referred or pulled thereto by service agent 20. Alternatively, the royalty structure could include a first royalty rates for service performed and a second, different royalty rate for parts ordered.

Referring to arrows 102, manufacturers 10a, b, or c can pay a royalty to association 18 based on parts ordered, and association 18 can provide an order activity summary periodically to manufacturers 10a, b, or c, indicating which transactions of manufacturers 10a, b, or c are subject to the royalty for the given period.

Each of the manufacturers comprising association 18 or operating under system 70 can manage the price, product part number, product descriptions, and other product information stored in database 74. Computer 72 is configured to receive product information from manufacturers 10a, b, or c, for example, over a secure communication link requiring a password, such that manufacturers 10a, b, or c can update their respective product information in database 74. Advantageously, computer 72 can always provide current pricing, part numbers, item numbers, etc., for manufacturers 10a, b, or c.

According to one advantageous aspect, credit card transactions (or other automated fund transfer methods such as ACH debit and EFT) can be the primary vehicle, or even the only vehicle, for processing financial transactions among association 18, service dealers 16a, b, and manufacturers 10a, b, or c. Service dealers 16a, b provide payment to manufacturers 10a, b, or c via credit card transaction, the fee payment from service dealers 16a, b to association 18 can be via credit card transaction, and the fee payment from manufacturers 10a, b, or c to association 18 can be via credit card transaction. Credit card transactions can include charge cards, check cards, and other credit-based transactions using computer 80.

According to one exemplary embodiment, association 18 can be a wholly-owned subsidiary of one of manufacturers 10a, b, or c, and the board of directors of association 18 can comprise members from multiple manufacturers.

According to one advantage, processes are streamlined and value is provided to both service dealers 16a, b and manufacturers 1a, b, or c, since the credit card processing and system 70 removes substantial administrative burden from service dealers 16a, b and manufacturers 10a, b, or c. In this sense, association 18 and system 70 operate as a facilitator of improved processing between manufacturers 10a, b, or c and service dealers 16a, b.

According to one embodiment, a process of improving payments from a service dealer to an association of manufacturers comprises receiving a request for a part from a service dealer, receiving account identification data (e.g., a credit card number) for an account associated with the service dealer, charging the account in an amount associated with the part cost, and charging the account for a service fee to be paid to the association of manufacturers. Further embodiments might include providing an order activity summary, providing a purchase order to a manufacturer, etc.

According to another alternative embodiment, a payment process for compensating an association of manufacturers for its facilitator role in a sales or service transaction can comprise forming a consortium of manufacturers, operating a computer system that facilitates the sales and/or service transactions between service dealers and members of the association, charging the service dealer a fee for use of the computer system, and charging a manufacturer a fee for use of the computer system. Further embodiments can comprise wherein the fee is based on total service or sales activity (or a flat fee), wherein the service dealer fees are charged to the same account number as part sales fees charged by the manufacturer, and reporting aspects.

According to another advantageous feature, a process of updating such a computer system can comprise the step of manufacturers updating their own product data on a computer system designed to hold part data for a plurality of manufacturers and an association of manufacturers.

According to another exemplary embodiment, computer 72 can comprise a database of service dealers and the service agent can access the database to search for and select a service dealer based upon a service dealer quality rating, location, and availability of parts for manufacturers 10a, b, or c, etc.

According to one advantageous aspect, manufacturers 10a, b, or c and service dealers 16a, b can be better able to track repair times, equipment servicing, and repairs for certain parts, based on data available from database 74.

While the exemplary embodiments illustrated in the FIGS. and described above are presently preferred, it should be understood that these embodiments are offered by way of example only. For example, the systems and methods described herein can be applied to other industries outside the construction industry. Further, the method can further comprise additional steps, such as, having one or more of manufacturers 10a, b, or c certify service dealers 16a, b to service manufacturers 10a, b, or c's products. According to another alternative embodiment, service agent 20a, b can be an agent, employee, and/or independent contractor of both association 18 and service dealers 16a, b. Accordingly, the present invention is not limited to a particular embodiment, but extends to various modifications that nevertheless fall within the scope of the appended claims.

What is claimed is:

1. A method of servicing construction equipment, comprising:
forming an association of construction equipment manufacturers; and
providing a service agent of the association, wherein the service agent refers a service need to a service dealer, wherein the service agent is not an agent of the service dealer to whom the service need is referred.

2. The method of claim 1, wherein the service agent is provided at a commercial construction job site to service the need of a contractor at the construction job site.

3. The method of claim 1, wherein the service dealer is a franchisee of the association.

4. The method of claim 1, further comprising training the service agent to understand equipment manufactured by the construction equipment manufacturers in the association.

5. The method of claim 1, wherein the service agent is not employed by or an independent contractor of the service dealer to whom the service need is referred.

6. The method of claim 1, wherein the service agent is employed by or an independent contractor of the association of construction equipment manufacturers.

7. The method of claim 1, wherein the association comprises a plurality of light construction equipment manufacturers.

8. The method of claim 7, wherein the light construction equipment manufacturers comprise a manufacturer which manufactures soil compaction equipment.

9. The method of claim 1, wherein a first of the construction equipment manufacturers sells equipment in a first product group and a second of the equipment manufacturers sells equipment in a second product group, wherein the first and second product groups are in different product lines.

10. The method of claim 1, wherein the service agent is employed by the association.

11. The method of claim 1, wherein the association is formed by contractually binding a group of independent construction equipment manufacturing companies.

12. The method of claim 1, wherein the service agent refers the service need to an independent service dealer.

13. A method of servicing construction equipment, comprising:
forming a consortium of construction equipment manufacturers; and
providing a service agent, wherein the service agent is an employee or independent contractor of the consortium and the service agent refers a service need to a service dealer.

14. The method of claim 13, wherein the service agent is not an employee or independent contractor of the service dealer to whom the service need is referred.

15. The method of claim 13, wherein the service dealer is a franchisee of the consortium.

16. The method of claim 13, wherein the service agent is provided to a customer's facility, a job site, and to an equipment dealer's facility.

17. A method of servicing construction equipment, comprising:
providing a service agent who is an agent of an association of construction equipment manufacturers; and
referring a service need with the service agent to a service dealer, wherein the service agent is not an agent of the service dealer to whom the service need is referred.

18. The method of claim 17, wherein the service agent is employed by or an independent contractor of the association of construction equipment manufacturers.

19. The method of claim 17, wherein the association is formed by contractually binding a group of independent construction equipment manufacturing companies.

20. The method of claim 17, wherein the service agent refers the service need to the service dealer who is a franchisee of the association.

21. The method of claim 17, wherein a plurality of members of the association are light construction equipment manufacturers.

22. An organization for a service system for construction equipment, the organization comprising:
an association of construction equipment manufacturers;
a service agent for processing service needs, the service needs being for the construction equipment; and
a plurality of service dealers, wherein the service agent is hired by the association and selects one of the service dealers to provide for the service need.

23. The organization of claim 22, wherein the association is formed by contractually binding a group of independent construction equipment manufacturing companies.

24. The organization of claim 22, wherein the service agent is provided at a commercial construction job site.

25. The organization of claim 22, wherein the service agent refers the service need to a service dealer who is a franchisee of the association.

26. An association of construction equipment manufacturers comprising a computer system configured to facilitate purchase orders between a service dealer and a manufacturer and further comprising a service agent, which is an agent of the association, wherein the service agent refers service needs to the service dealer.

27. The association of claim 26, wherein the construction equipment manufacturers are bound contractually in the form of a consortium.

28. The association of claim 26, wherein the service agent is employed by the association.

29. The association of claim 26, wherein the service agent is not employed by or an independent contractor of the service dealer.

30. The association of claim 26, wherein the service agent refers the service needs to the service dealer who is a franchisee of the association.
